(19) United States
(12) Patent Application Publication
(10) Pub. No.: US 2006/0147343 A1
(43) Pub. Date: Jul. 6, 2006

(54) Analyzer instrument whith liquid storage portion

(75) Inventor: Masaaki Teramoto, Kyoto (JP)

Correspondence Address: HAMRE, SCHUMANN, MUELLER & LARSON, P.C., P.O. BOX 2902-0902, MINNEAPOLIS, MN, 55402, US

(73) Assignee: Arkray, Inc., Kyoto-shi, Kyoto (JP)

(21) Appl. No.: 10/560,204

(22) PCT Filed: Jun. 15, 2004
(86) PCT No.: PCT/JP04/08347

§ 371 Date: Dec. 8, 2005

(30) Foreign Application Priority Data
Jun. 19, 2003 (JP) 2003-175247

(51) Int. Cl. G01N 31/22

(52) U.S. Cl. 422/68.1; 422/57

(57) ABSTRACT

The present invention relates to an analytical tool (1A) which includes a flow path (8A) for moving a sample, a sample introduction port (73A), and a liquid reservoir (7A) for reserving the sample to be introduced into the flow path (8A) The flow path (8A) and the liquid reservoir (7A) are configured to cause suction force to act on both the flow path and the liquid reservoir. The suction force to act on the liquid reservoir (7A) is smaller than the suction force to act on the flow path (8A). The sectional area of the liquid reservoir (7A) in a perpendicular direction which is perpendicular to the movement direction of the sample is set larger than the sectional area of the flow path (8A) in the perpendicular direction. Preferably, the capacity of the liquid reservoir (7A) is set larger than the capacity of the flow path (8A).

### TECHNICAL FIELD

The present invention relates to an analytical tool used for analyzing a particular component (such as glucose, cholesterol or lactic acid) contained in a sample (e.g. biochemical sample such as blood or urine)

### BACKGROUND ART

To measure a glucose level in blood, a method which utilizes a disposable biosensor is often employed as an easy method of measurement (See Patent Documents 1 and 2, for example). As shown in FIG. 17 of the present application, the biosensor 9A disclosed in the above documents is designed to move a sample by utilizing a capillary force generated in the capillary 90A. In the biosensor 9A, however, the suction of the sample stops unless the sample is kept in contact with the suction port 91A. Therefore, to introduce blood from skin into the capillary 90A, the biosensor 9A need be kept in contact with the skin for a relatively long time, which is inconvenient. When the contact time with the skin is short, blood of an amount sufficient for the measurement may not be introduced into the capillary 90A.

As shown in FIG. 18 of the present application, an analytical tool 9B which includes a liquid reservoir 92B has also been proposed (See Patent Documents 3 and 4, for example). The liquid reservoir 92B of the analytical tool 9B is open upward and sideward and does not generate a capillary force. Therefore, to reserve a sufficient amount of blood in the liquid reservoir 92B, blood is extracted from skin while closing the openings of the liquid reservoir 92B and the suction port 91B of the capillary 90B with skin. The blood extracted from the skin is retained in the liquid reservoir 92B and then introduced into the capillary 90B through the suction port 91B.

Since a suction force does not act on the liquid reservoir 92B in the analytical tool 9B, the analytical tool 9B need be inconveniently kept in contact with the skin for a relatively long time, similarly to the foregoing biosensor 9A (See FIG. 17). Moreover, since blood is introduced into the capillary 90 after reserved in the liquid reservoir 92B, it takes a relatively long time before the capillary 90B is filled with blood. Further, since the analytical tool 9B need be brought into contact with skin in such a manner as to close both of the liquid reservoir 92B and the suction port 91B in extracting blood, the blood extraction operation is troublesome. Since there is a limitation on the portion of skin which can close both of the liquid reservoir 92B and the suction port 91B, the portion of skin from which blood can be extracted is limited.

Patent Document 1: JP-A 2001-159618

Patent Document 2: JP-A 2001-305093

Patent Document 3: JP-A 2001-525554

Patent Document 4: JP-A 7-55801

### DISCLOSURE OF THE INVENTION

An object of the present invention is to provide an analytical tool which includes a flow path for moving a sample and which is capable of reliably supplying a predetermined amount of sample into the flow path in a short time period.

According to the present invention, there is provided a liquid reserving analytical tool comprising a flow path for moving a sample, a sample introduction port, and a liquid reservoir for reserving the sample to be introduced into the flow path. The flow path and the liquid reservoir are configured to cause suction force to act on both the flow path and the liquid reservoir. The suction force acting on the liquid reservoir is smaller than the suction force acting on the flow path.

For instance, the sectional area of the liquid reservoir in a perpendicular direction which is perpendicular to the movement direction of the sample is larger than the sectional area of the flow path in the perpendicular direction. Preferably, the liquid reservoir is larger than the flow path in capacity. For instance, the capacity of the liquid reservoir is set to no less than 1 μL. More preferably, the capacity of the liquid reservoir is set to 2 to 4 μL, whereas the capacity of the flow path is set to no more than 2 μL.

For instance, the flow path and the liquid reservoir are provided on a plate member. In this case, the dimension of the liquid reservoir in the thickness direction of the plate member is larger than the dimension of the flow path in the thickness direction. For instance, the dimension of the liquid reservoir in the width direction (which is perpendicular to both of the movement direction and the thickness direction) and the dimension of the flow path in the width direction are equal or generally equal to each other.

The analytical tool of the present invention further comprises a first plate member, and a second plate member stacked on the first plate member via at least one spacer.

The at least one spacer includes at least one first spacer and at least one second spacer. For instance, in this case, the dimension of the flow path in the thickness direction of the first and the second plate members is defined by at least one first spacer, and the dimension of the liquid reservoir in the thickness direction is defined by at least one first spacer and at least one second spacer.

At least one first spacer may define the dimension of the flow path in the width direction.

At least one first spacer and at least one second spacer include a cutout for defining the dimension of the liquid reservoir in the width direction. For instance, the cutout has a width which increases as the cutout extends away from the flow path in a direction opposite from the movement direction.

For instance, at least one second spacer includes a plurality of spacers stacked in the thickness direction.

For instance, at least one of the first plate and the second plate includes a bulging portion which projects in the thickness direction to increase the capacity of the liquid reservoir. In this case, the sample introduction port is open in a direction opposite from the movement direction, for example.

For instance, at least one of the first plate and the second plate includes a recess denting in the thickness direction of the first and the second plates to increase the capacity of the liquid reservoir. In this case, the sample introduction port is open in the thickness direction, for example.

For instance, in the analytical tool of the present invention, the suction force acts on the flow path and the liquid reservoir as a capillary force.

In the liquid reserving analytical tool of the present invention, in the flow path is provided a reagent portion which shows a color in accordance with an amount of a target component contained in the sample so that analysis of the target component can be performed by an optical method. Alternatively, the concentration of an analysis target component, for example, may be outputted as an electrical physical quantity.

The analytical tool of the present invention is typically adapted to use a biochemical sample such as blood, urine, saliva or preparations of these. Herein, the preparations include at least a diluted solution, a supernatant obtained by centrifugation or a mixture with a particular reagent.

The analytical tool of the present invention may be so designed that the sample introduction port can be brought into close contact with skin to extract blood from the skin when whole blood is used as the sample. Preferably, in this case, the sample introduction port is in the form of a regular polygon or generally regular polygon, or is circular or generally circular.

### BRIEF DESCRIPTION OF THE DRAWINGS

FIG. 1 is an overall perspective view of a glucose sensor according to a first embodiment of the present invention.

FIG. 2 is a sectional view taken along lines II-II in FIG. 1.

FIG. 3 is an exploded perspective view of the glucose sensor shown in FIG. 1.

FIG. 4 includes sectional views corresponding to FIG. 2 for describing the blood introduction operation of the glucose sensor shown in FIG. 1.

FIG. 5 is an overall perspective view showing another example of glucose sensor.

FIG. 6 is an exploded perspective view of the glucose sensor shown in FIG. 5.

FIG. 7 is an overall perspective view of a glucose sensor according to a second embodiment of the present invention.

FIG. 8 is a sectional view taken along lines VIII-VIII in FIG. 7.

FIG. 9 is an overall perspective view of a glucose sensor according to a third embodiment of the present invention.

FIG. 10 is a sectional view taken along lines X-X in FIG. 9.

FIG. 11 is an exploded perspective view of a glucose sensor according to a fourth embodiment of the present invention.

FIG. 12 is a sectional view of the glucose sensor shown in FIG. 11.

FIG. 13 is a graph showing the results of Example 1.

FIG. 14 is a graph showing the results of Example 2.

FIG. 15 includes graphs showing the results of Example 3.

FIG. 16 includes graphs showing the results of Example 4.

FIG. 17 is a sectional view showing an example of prior art biosensor.

FIG. 18 is a sectional view showing another example of prior art biosensor.

### BEST MODE FOR CARRYING OUT THE INVENTION

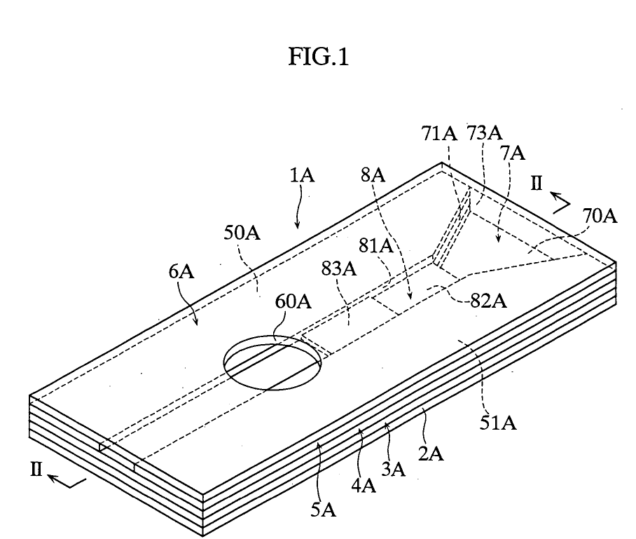

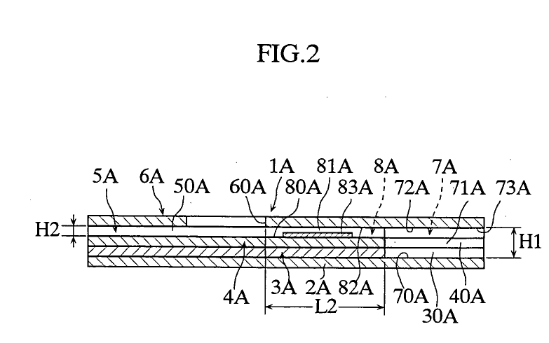

The glucose sensor 1A shown in FIGS. 1 through 3 is a disposable sensor designed to measure a blood glucose level by colorimetry. The glucose sensor 1A comprises a substrate 2A, and a cover 6A bonded to the substrate via spacers 3A-5A. These members 2A-6A define a liquid reservoir 7A and a capillary 8A.

The substrate 2A defines the bottom surface 70A of the liquid reservoir 7A and has an elongated rectangular configuration. The substrate 2A is made of resin such as PET, PMMA or vinylon to be transparent for transmitting light. In the substrate 2A, the surface facing the liquid reservoir 7A is made hydrophilic. Such a substrate 2A can be provided by making the entirety of the substrate 2A by using a material having a high wettability such as vinylon or high-crystalline PVA or hydrophilically treating the surface of the substrate 2A which faces the capillary 8A. For example, the hydrophilic treatment may be performed by the irradiation of ultraviolet rays or the application of a surfactant such as lecithin.

The spacers 3A and 4A serve to define the height of the liquid reservoir 7A and a side surface 71A of the liquid reservoir 7A and have the same configuration in plan view. Specifically, the spacers 3A and 4A, as a whole, have an elongated rectangular configuration and include cutouts 30A and 40A. The cutouts 30A and 40A provide the side surface 71A of the liquid reservoir 7A and expose part of the substrate 2A. The spacer 3A may be made of e.g. a double-sided tape and is transparent. The spacer 4A is made of resin to be transparent similarly to the substrate 2A, for example. The surfaces of the spacer 4A which face the liquid reservoir 7A and the capillary 8A are made hydrophilic by a technique similar to that for the substrate 2A.

The spacer 5A serves to define the height of the liquid reservoir 7A along with the spacers 3A and 4A, and also defines the width and height of the capillary 8A. The spacer 5A includes a first and a second elements 50A and 51A having the same configuration and respectively including cutouts 52A and 53A for defining the side surface 71A of the liquid reservoir 7A. The elements 50A and 51A are spaced from each other by a predetermined distance and arranged axisymmetrically on the spacer 4A so that the cutouts 52A and 53A align with the cutouts 30A and 40A of the spacers 3A and 4A. As a result, the spacer 5A (the first and the second elements 50A and 51A) defines, on the spacer 4A, a groove extending in the longitudinal direction of the substrate 2A, and the groove defines the bottom surface 80A and the side surface 81A of the capillary 8A.

The cover 6A defines the upper surfaces 72A and 82A of the liquid reservoir 7A and the capillary 8A and has an elongated rectangular configuration as a whole. The cover 6A is made of resin such as PET, PMMA or vinylon to be transparent for transmitting light. The cover 6A is formed with a through-hole 60A for discharging gas from within the capillary 8A. However, since the capillary 8A of the glucose sensor 1A is open laterally, the through-hole 60A need not necessarily be provided, and the gas within the capillary may be discharged through the laterally open portion of the capillary 8A. The surfaces of the cover 6A which face the liquid reservoir 7A and the capillary 8A are made hydrophilic by a technique similar to that for the substrate 2A, for example.

The liquid reservoir 7A, which serves to reserve blood before the blood is introduced into the capillary 8A, is connected to the capillary 8A. The liquid reservoir 7A includes a sample introduction port 73A which opens laterally and is so designed that a suction force from the sample introduction port 73A toward the capillary 8A is exerted. The suction force to act on the liquid reservoir 7A is set smaller than the suction force to act on the capillary 8A, which will be described later.

The capacity of the liquid reservoir 7A is set larger than that of the capillary 8A. As is clear from the above description, the capacity of the liquid reservoir 7A is made relatively large by interposing the spacers 3A and 4A provided with cutouts 30A and 40A between the substrate 2A and the cover 6A in addition to the spacer 5A. When the glucose sensor 1A is designed to measure a blood glucose level by using a slight amount of blood, the capacity of the liquid reservoir 7A is set to 2 to 4 μL, for example.

The capillary 8A generates a capillary force and moves the blood reserved in the liquid reservoir 7A. As is clear from the above description, the capacity of the capillary 8A is set smaller than that of the liquid reservoir 7A. When the glucose sensor 1A is designed to measure a blood glucose level by using a slight amount of blood, the capacity of the capillary 8A is set to no more than 2 μL, for example.

A reagent portion 83A is provided in the capillary 8A. The reagent portion 83A is in a porous solid state soluble in blood and contains a color former. Therefore, when blood is introduced into the capillary 8A, a liquid phase reaction system including glucose and the color former is established in the capillary 8A.

Although various kinds of color former can be used, it is preferable to use a color former whose absorption wavelength in developing a color due to electron transfer differs from the absorption wavelength of blood. As the color former, use may be made of MTT (3-(4,5-Dimethyl-2-thiazolyl)-2, 5-diphenyl-2H-tetrazolium bromide), for example.

The reagent portion 83A may include an electron mediator and an oxidoreductase. In such a case, the electron transfer between glucose and the color former occurs quickly, whereby the measurement time can be shortened.

As the oxidoreductase, use may be made of GDH or GOD, and typically, PQQGDH may be used. As the electron mediator, use may be made of [Ru(NH₃)₆]Cl₃, K₃[Fe(CN)₆] or methoxy-PMS (5-methylphenazinium methylsulfate), for example.

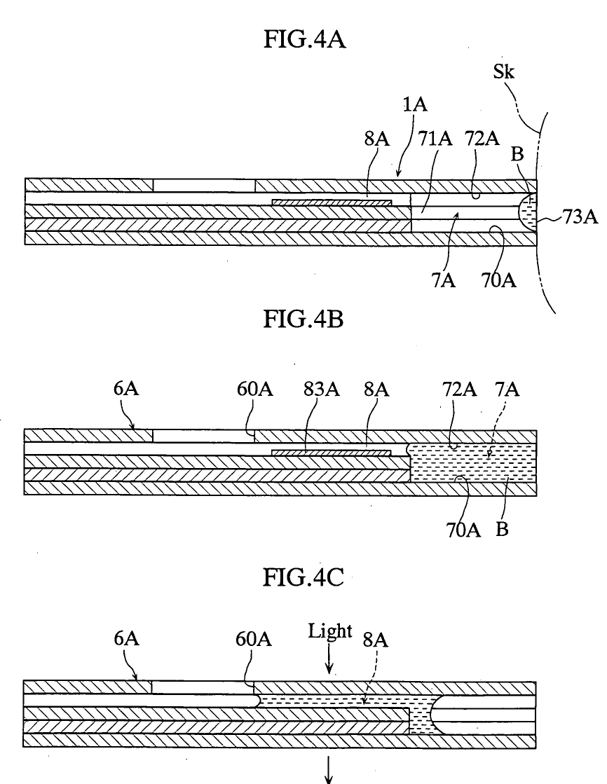

Referring to FIGS. 4A-4C, an example of glucose level measurement method using the glucose sensor 1A will be described.

As shown in FIG. 4A, in the glucose sensor 1A, blood B is introduced by lancing the skin Sk to cause bleeding from the skin Sk and then bringing the glucose sensor 1A into contact with the skin Sk while positioning the sample introduction port 73A at the blood B. When the glucose sensor 1A is brought into contact with the skin Sk in this way, the blood B comes into contact with the edge of the sample introduction port 73A. At this time, as shown in FIGS. 4A and 4B, the blood B moves along the upper surface 72A, the bottom surface 70A and the side surface 71A of the liquid reservoir 7A toward the capillary 8A due to the suction force acting on the liquid reservoir 7A. In this way, the blood B is introduced into the liquid reservoir 7A.

As shown in FIGS. 4B and 4C, when the blood B reaches the capillary 8A, the blood B is introduced into and moves through the capillary 8A due to the capillary force generated in the capillary 8A. The movement of the blood B stops when the blood B reaches the edge of the through-hole 60A of the cover 6A. When the blood B is supplied to the capillary 8A, the reagent portion 83A dissolves by the blood B. As a result, in the capillary 8A, a liquid phase reaction system is established which includes glucose and a color former or includes an oxidoreductase and an electron mediator in some cases.

In the liquid phase reaction system, electrons removed from glucose are supplied to the color former to cause the color former to develop a color, whereby the liquid phase reaction system is colored. When the reagent portion 83A includes an oxidoreductase and an electron mediator, the oxidoreductase reacts specifically with glucose in blood to remove electrons from glucose, and the electrons are supplied to the electron mediator and then to the color former. Therefore, the degree of color development of the color former (the degree of coloring of the liquid phase reaction system) relates with the amount of electrons removed from glucose, i.e. the glucose level.

The degree of coloring of the liquid phase reaction system can be detected by irradiating the liquid phase reaction system with light through the cover 6A and receiving the light passed through the liquid phase reaction system and emitted from the substrate 2A. As the light to illuminate the liquid phase reaction system, the light of a wavelength which is greatly absorbed by the color former at the developed color is employed. The glucose level can be computed based on the intensity of the light incident on the liquid phase reaction system and the intensity of the light transmitted through the liquid phase reaction system.

As noted above, in the glucose sensor 1A, the sample introduction port 73A is open only laterally, and a suction force acts on the liquid reservoir 7A. Therefore, even when the time period during which the liquid reservoir 7A is held in contact with the skin Sk is relatively short, blood can be introduced into the liquid reservoir 7A in the relatively short time period.

Further, the glucose sensor 1A has the following characteristics. Firstly, the blood B is introduced into the capillary 8A after reserved in the liquid reservoir 7A. Secondly, the suction force acting on the capillary 8A is set larger than the suction force acting on the liquid reservoir 7A. Thirdly, the capacity of the liquid reservoir 7A is set larger than the capacity of the capillary 8A. Therefore, after a sufficient amount of blood is reserved in the liquid reservoir 7A, the blood can fill the capillary 8A in a short period of time after reaching the capillary 8A. Therefore, in the glucose sensor 1A, a sufficient amount of blood B can be reliably introduced into the capillary 8A so that the glucose level can be measured accurately.

In this embodiment, the height and capacity of the liquid reservoir 7A is increased by the provision of three spacers 3A-5A. However, the spacers 3A and 4A may be dispensed with, and the capacity of the liquid reservoir 7A may be defined only by the cutouts 52A and 53A of the spacer 5A.

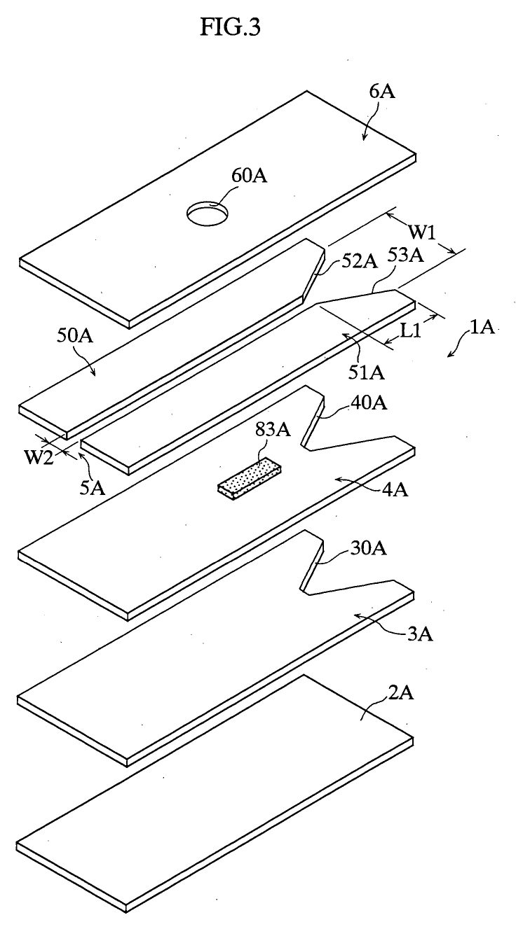

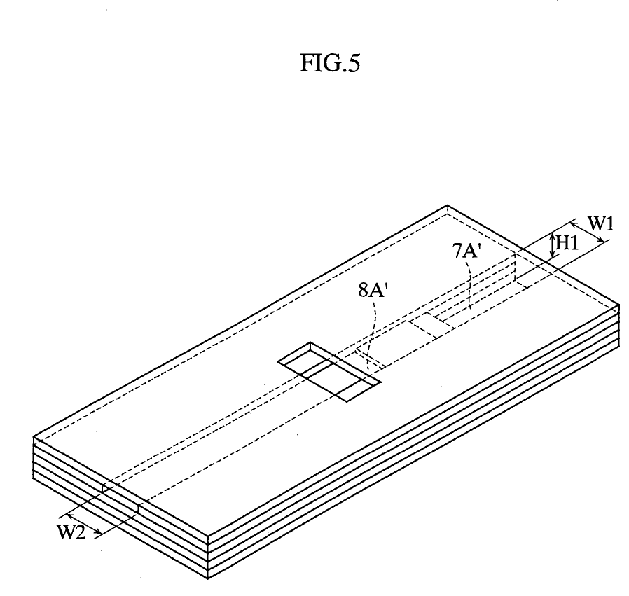

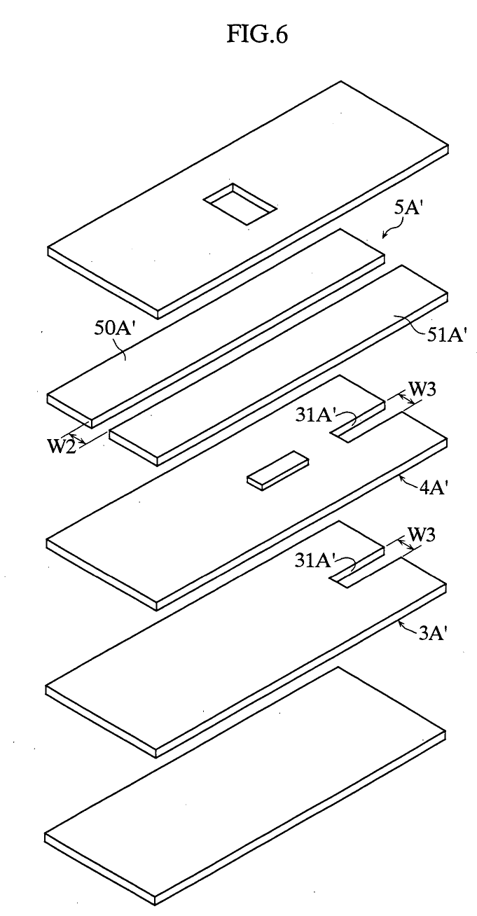

As shown in FIG. 5, the width W1 of the liquid reservoir 7A′ and the width W2 of the capillary 8A′ may be set equal to each other. In this case, the capacity of the liquid reservoir 7A′ can be made larger than that of the capillary 8A′ by increasing the height H1 of the liquid reservoir 7A′. As shown in FIG. 6, such a liquid reservoir 7A′ can be provided by spacers 3A′ and 4A′ formed with cutouts 30A′ and 40A′ of a width W3 which is equal to the width of the capillary 8A′, and a first and a second elements 50A′ and 51A′ of a spacer 5A′ which are not formed with cutouts (See reference signs 52A and 53A in FIG. 3).

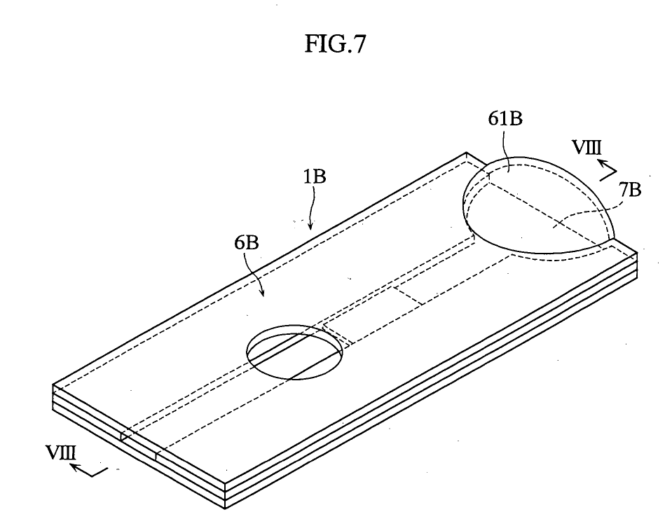

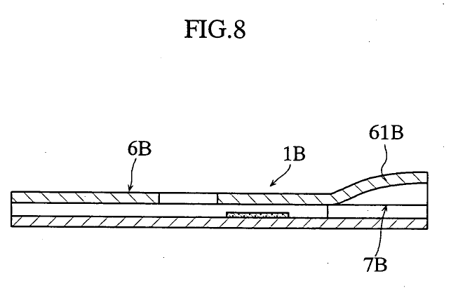

Next, with reference to FIGS. 7 and 8, a second embodiment of the present invention will be described.

The glucose sensor 1B shown in FIGS. 7 and 8 is basically the same in structure as the above-described glucose sensor 1A (See FIGS. 1 through 3) but differs from the glucose sensor 1A in structure of the liquid reservoir 7B.

The liquid reservoir 7B is designed to have a large capacity by changing the configuration of the cover 6B. Specifically, in the glucose sensor 1B, the cover 6B is formed with a bulging portion 61B which bulges upward to increase the capacity of the liquid reservoir.

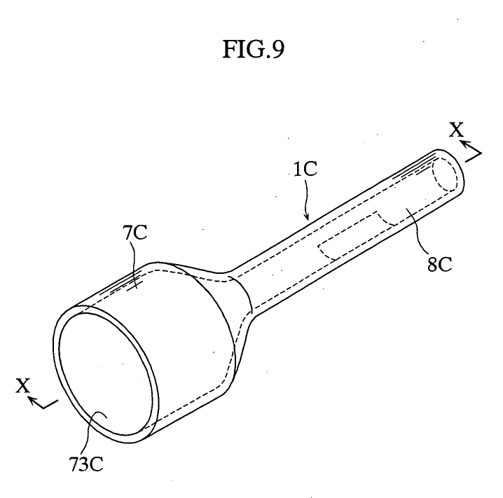

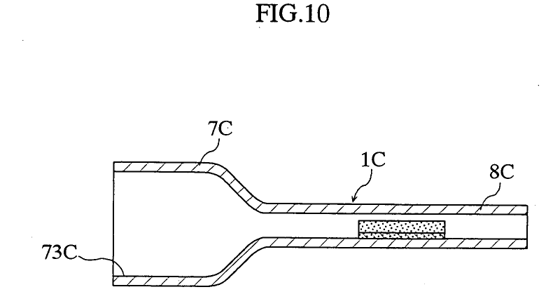

Next, with reference to FIGS. 9 and 10, a third embodiment of the present invention will be described.

The glucose sensor 1C shown in FIGS. 9 and 10 has a rounded configuration. Specifically, both of the liquid reservoir 7C and the capillary 8C are cylindrical, and the inner diameter of the liquid reservoir 7C is set larger than that of the capillary 8C. With such a structure, the suction force generated at the capillary 8C is greater than the suction force generated at the liquid reservoir 7C, and the capacity of the liquid reservoir 7C is larger than that of the capillary 8C. Such liquid reservoir 7C and capillary 8C can be integrally formed with each other by resin molding, for example.

In the glucose sensor 1C, the liquid reservoir 7C is cylindrical. As a result, the sample introduction port 73C is circular. When skin is lanced to cause bleeding, blood comes out as a spherical drop. Therefore, by making the shape of the sample introduction port 73C conform to the shape of the blood drop, the blood can be introduced into the liquid reservoir 7C further reliably. Such an advantage can be obtained not only when the sample introduction port 73C is circular but also when the sample introduction port 73C has a shape close to circular or is in the form of a regular polygon (typically square).

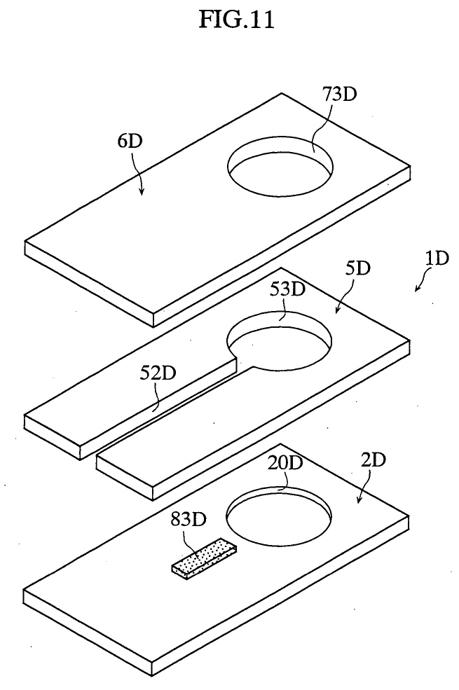

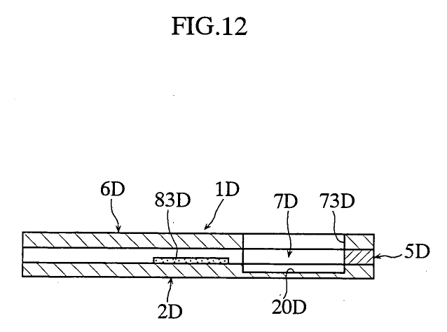

Next, with reference to FIGS. 11 and 12, a fourth embodiment of the present invention will be described.

In the glucose sensor 1D shown in FIGS. 11 and 12, the sample introduction port 73D is open upward, and the cover 6D is stacked to the substrate 2D via the spacer 5D.

The substrate 2D is provided with a reagent portion 83D for accommodation in the capillary 8D. The substrate 2D is further formed with a recess 20D constituting the liquid reservoir 7D. The provision of the recess 20D increases the capacity of the liquid reservoir 7D.

The spacer 5D is formed with a first opening 52D in the form of a slit and a second opening 53D which is circular. The first opening 52D defines the width and height of the capillary 8D, whereas the second opening 53D, along with the recess 20D of the substrate 2D, defines the capacity of the liquid reservoir 7D.

In the glucose sensor 1D, the sample introduction port 73D is open upward at the cover 6D. That is, the sample introduction port 73D is formed to be open at a relatively large flat surface. Therefore, in introducing blood into the liquid reservoir 7D of the glucose sensor 1D, the contact area with the skin can be made relatively large. Therefore, the glucose sensor 1D can be brought into close contact with the skin while maintaining a stable posture. Therefore, the operation to introduce blood into the sample introduction port 73D can be facilitated, and blood can be stably extracted from various portions.

In the foregoing embodiments, description is given of a glucose sensor designed to measure a glucose level based on the intensity of incident light and transmitted light. However, the present invention is also applicable to a glucose sensor designed to measure a glucose level based on the intensity of incident light and reflected light. The present invention is not limited to a glucose sensor designed to measure a glucose level by colorimetry but applicable to a glucose sensor designed to measure a glucose level by an electrode method.

The present invention is also applicable to the measurement of a component in blood other than glucose, i.e. the measurement of cholesterol or lactic acid, for example, and also applicable to the analysis of a sample other than blood, i.e. the analysis of urine or saliva, for example.

### EXAMPLES

The influence of the capacities of the liquid reservoir and capillary of a glucose sensor on the introduction of blood was studied as Examples 1 through 4.

(Preparation of Glucose Sensor)

In each of the Examples, glucose sensors having the structure shown in FIGS. 1 through 3 were used. The widths W1, W2, lengths L1, L2 and heights H1, H2 of the liquid reservoir 7A and the capillary 8A are as specified in each Example. In each Example, glucose sensors which were not provided with a reagent portion were used.

As the substrate 2A, the spacer 4A and the cover 6A, those made of PET and treated with lecithin (hydrophilization) by a conventional method were used. As the spacers 3A and 5A, use was made of a double-sided tape (Tradename: 8616S; available from DAINIPPON INK AND CHEMICALS, INCORPORATED).

### Example 1

In this example, with the capacity of the capillary 8A fixed, study was made of the relationship between the capacity of the liquid reservoir 7A (height of the liquid reservoir 7A) and the distance through which blood moves in the capillary 8A.

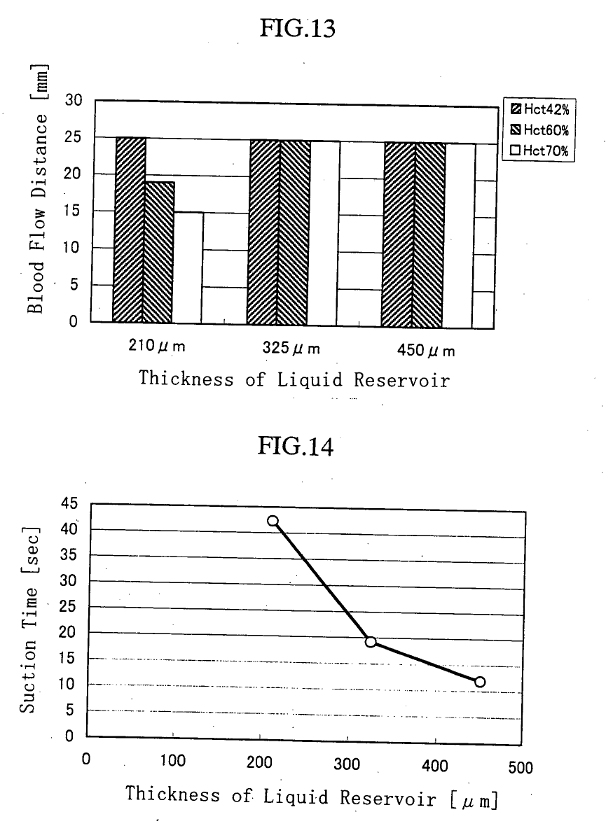

In this example, as shown in Table 1 below, use were made of three kinds of glucose sensors 1-1, 1-2 and 1-3 which were the same in capacity V2 and configuration of the capillary 8A but different from each other in capacity V1 (thickness H1) of the liquid reservoir 7A. The movement distance of blood in the capillary 8A was measured at the time point when the movement of blood was stopped after a predetermined amount of blood was introduced into the liquid reservoir 7A. The introduction of blood into the liquid reservoir 7A was performed by placing 5 μL of blood on a Parafilm and bringing the sample introduction port 73A of the glucose sensor 1A into contact with the blood. When the introduction of blood into the liquid reservoir 7A was confirmed, the glucose sensor 1A was separated from the blood. As blood, whole blood adjusted to a Hct of 42%, 60% or 70% was used. The measurement results of the movement distance are given in FIG. 13.

TABLE 1

| | Liquid Reservoir | | | | Capillary | | | |
|---|---|---|---|---|---|---|---|---|
| sensor | | | | Capacity | | | | Capacity |
| No. | W1 | L1 | H1 | V1 | W2 | L2 | H2 | V2 |
| 1-1 | 5 mm | 2.5 mm | 210 μm | 1.3125 mm³ | 1 mm | 25 mm | 60 μm | 1.5 mm³ |
| 1-2 | | | 325 μm | 2.03125 mm³ | | | | |
| 1-3 | | | 450 μm | 2.8125 mm³ | | | | |

As is clear from FIG. 13, when the thickness H1 of the liquid reservoir 7A was relatively large and hence the capacity V1 of the liquid reservoir 7A was relatively large (Sensor Nos. 1-2 and 1-3), the capillary 8A was reliably filled with blood. On the other hand, when the thickness H1 of the liquid reservoir 7A was relatively small and hence the capacity V1 of the liquid reservoir 7A was relatively small (Sensor No. 1), the capillary 8A could not be filled with blood in the case where the Hct of the blood was high (Hct 60%, 70%).

Since the capacity V2 of the capillary 8A is set to 1.5 mm³ in the sensors 1-1 through 1-3, the capacity V1 of the liquid reservoir 7A becomes equal to the capacity V2 of the capillary 8A when the height H1 of the liquid reservoir 7A is 240 μm. From this point, it is found that the capacity V1 of the liquid reservoir 7A is larger than the capacity V2 of the capillary 8A in the sensor Nos. 1-2 and 1-3, whereas the capacity V1 of the liquid reservoir 7A is smaller than the capacity V2 of the capillary 8A in the sensor No. 1-1. This point and the above-described measurement results reveal that even the blood having a high Hct can be reliably introduced from the liquid reservoir 7A into the capillary 8A by setting the capacity V1 of the liquid reservoir 7A larger than the capacity V2 of the capillary 8A.

### Example 2

In this example, with the capacity of the capillary 8A fixed, study was made of the relationship between the thickness H1 of the liquid reservoir 7A (capacity of the liquid reservoir 7A) and the suction time required to move blood through a predetermined distance in the capillary 8A.

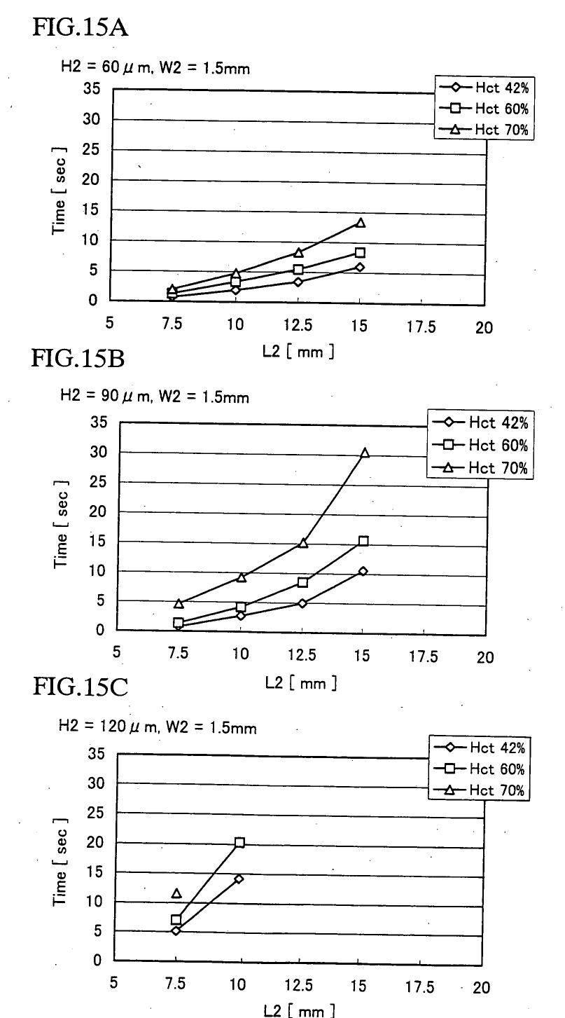

Similarly to Example 1, three kinds of glucose sensors (See Table 1 above) differing from each other in thickness H1 of the liquid reservoir 7A were used in this Example. As the suction time, after a predetermined amount of blood was introduced into the liquid reservoir 7A, the time taken for the blood to move 25 mm in the capillary 8A was measured. The introduction of blood into the liquid reservoir 7A was performed similarly to Example 1. As blood, whole blood adjusted to a Hct of 42% was used. The results of measurement are given in FIG. 14.

As will be understood from FIG. 14, a glucose sensor having a larger thickness H1 of the liquid reservoir 7A requires shorter suction time and hence is capable of reliably introducing blood into the capillary 8A in a shorter time period.

### Example 3, Example 4

In Example 3 and Example 4, with the capacity of the liquid reservoir 7A fixed, examination was made of the influence of the capacity of the capillary 8A on the suction time.

In Example 3, as shown in Table 2 below, the capacity V2 of the capillary 8A was adjusted by changing the height H2 and the length L2 while fixing the width W2 of the capillary 8A. In Example 4, as shown in Table 3 below, the capacity V2 of the capillary 8A was adjusted by changing the height H2 and the width W2 while fixing the length L2 of the capillary 8A.

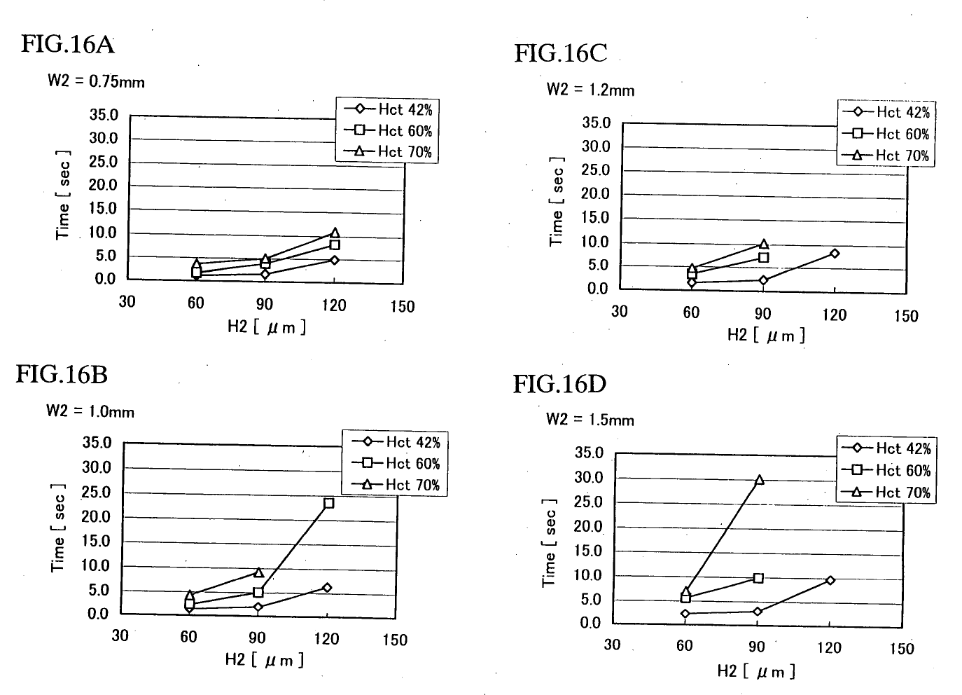

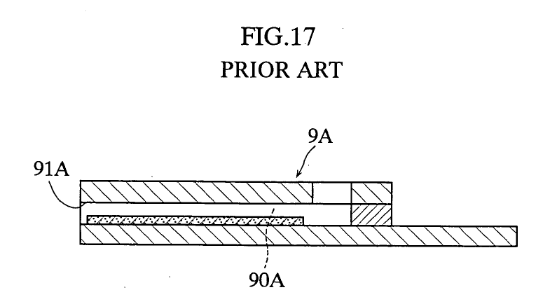

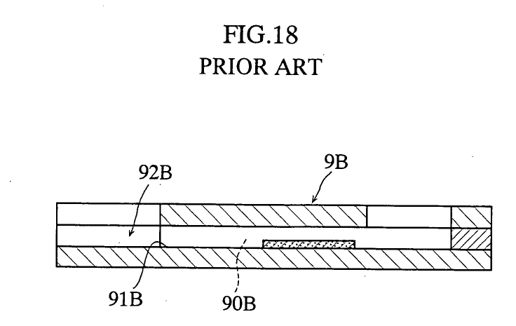

The measurement of the suction time was performed similarly to Example 2. As blood, whole blood adjusted to a Hct of 42%, 60% or 70% was used. The results are shown in FIGS. 15A-15C and 16A-16D. FIG. 15A shows the results when the length L2 of the capillary 8A is changed, with the height H2 of the capillary 8A fixed to 60 μm. FIG. 15B shows the results when the length L2 of the capillary 8A is changed, with the height H2 of the capillary 8A fixed to 90 μm. FIG. 15C shows the results when the length L2 of the capillary 8A is changed, with the height H2 of the capillary 8A fixed to 120 μm. On the other hand, FIG. 16A shows the results when the height H2 of the capillary 8A is changed, with the width W2 of the capillary 8A fixed to 0.75 mm. FIG. 16B shows the results when the height H2 of the capillary 8A is changed, with the width W2 of the capillary 8A fixed to 1.0 mm. FIG. 16C shows the results when the height H2 of the capillary 8A is changed, with the width W2 of the capillary 8A fixed to 1.2 mm. FIG. 16D shows the results when the height H2 of the capillary 8A is changed, with the width W2 of the capillary 8A fixed to 1.5 mm.

In FIGS. 15C, 16C and 16D, the plot point is omitted with respect to the case where the capillary 8A was not filled with blood even after the lapse of one minute from the start of the measurement.

TABLE 2

| | Liquid Reservoir | | | | Capillary | | | | |
|---|---|---|---|---|---|---|---|---|---|
| Sensor | | | | Capacity | | | | Capacity | |
| No. | H1 | L1 | W1 | V1 | H2 | L2 | W2 | V2 | |
| 3-1 | 325 μm | 2.0 mm | 5.0 mm | 1.625 mm³ | 60 μm | 7.5 mm | 1.5 mm | 0.675 | mm³ |
| 3-2 | | | | | | 10.0 mm | | 0.9 | mm³ |
| 3-3 | | | | | | 12.5 mm | | 1.125 | mm³ |
| 3-4 | | | | | | 15.0 mm | | 1.35 | mm³ |
| 3-5 | 325 μm | 2.0 mm | 5.0 mm | 1.625 mm³ | 90 μm | 7.5 mm | 1.5 mm | 1.0125 | mm³ |
| 3-6 | | | | | | 10.0 mm | | 1.35 | mm³ |
| 3-7 | | | | | | 12.5 mm | | 1.6875 | mm³ |
| 3-8 | | | | | | 15.0 mm | | 2.025 | mm³ |
| 3-9 | 325 μm | 2.0 mm | 5.0 mm | 1.625 mm³ | 120 μm | 7.5 mm | 1.5 mm | 1.35 | mm³ |
| 3-10 | | | | | | 10.0 mm | | 1.8 | mm³ |
| 3-11 | | | | | | 12.5 mm | | 2.25 | mm³ |
| 3-12 | | | | | | 15.0 mm | | 2.7 | mm³ |

TABLE 3

| | Liquid Reservoir | | | | Capillary | | | | | |
|---|---|---|---|---|---|---|---|---|---|---|
| Sensor | | | | Capacity | | | | | Capacity | |
| No. | H1 | W1 | L1 | V1 | H2 | W2 | | L2 | V2 | |
| 4-1 | 325 μm | 5.0 mm | 2.0 mm | 1.625 mm³ | 60 μm | 0.75 | mm | 9 mm | 0.405 | mm³ |
| 4-2 | | | | | | 1.0 | mm | | 0.54 | mm³ |
| 4-3 | | | | | | 1.2 | mm | | 0.648 | mm³ |
| 4-4 | | | | | | 1.5 | mm | | 0.81 | mm³ |
| 4-5 | 325 μm | 5.0 mm | 2.0 mm | 1.625 mm³ | 90 μm | 0.75 | mm | 9 mm | 0.6075 | mm³ |
| 4-6 | | | | | | 1.0 | mm | | 0.81 | mm³ |
| 4-7 | | | | | | 1.2 | mm | | 0.972 | mm³ |
| 4-8 | | | | | | 1.5 | mm | | 1.215 | mm³ |
| 4-9 | 325 μm | 5.0 mm | 2.0 mm | 1.625 mm³ | 120 μm | 0.75 | mm | 9 mm | 0.81 | mm³ |
| 4-10 | | | | | | 1.0 | mm | | 1.08 | mm³ |
| 4-11 | | | | | | 1.2 | mm | | 1.296 | mm³ |
| 4-12 | | | | | | 1.5 | mm | | 1.62 | mm³ |

As will be understood from FIGS. 15A-15D and 16A-16D, the capillary 8A having a larger capacity V2 requires longer suction time, and blood having a higher Hct requires longer suction time and sometimes cannot fill the capillary 8A. Similarly to the results of Examples 1 and 2, the results indicates that it is basically preferable to set the capacity of the capillary 8A smaller than the capacity V1 of the liquid reservoir 7A.

Further, Example 4 indicates the following point as well. Although glucose sensors in which the capacity V2 of the capillary 8A was smaller than the capacity V1 of the liquid reservoir 7A were used in Example 4, sufficient suction of blood into the capillary 8A could not be performed in some cases even when the capacity V2 of the capillary 8A was smaller than the capacity V1 of the liquid reservoir 7A. Conceivably, this is because the length L2 of the capillary 8A was set relatively long, i.e. to 9 mm in Example 4. Therefore, the results of Example 4 indicates that the length of the capillary 8A should not be set longer than necessary.

1. A liquid reserving analytical tool comprising a flow path for moving a sample, a sample introduction port, and a liquid reservoir for reserving the sample to be introduced into the flow path;
wherein the flow path and the liquid reservoir are configured to cause suction force to act on both the flow path and the liquid reservoir, the suction force acting on the liquid reservoir becomes smaller than the suction force acting on the flow path.

2. The liquid reserving analytical tool according to claim 1, wherein a sectional area of the liquid reservoir in a perpendicular direction which is perpendicular to a movement direction of the sample is larger than a sectional area of the flow path in the perpendicular direction.

3. The liquid reserving analytical tool according to claim 2, wherein the liquid reservoir is larger than the flow path in capacity.

4. The liquid reserving analytical tool according to claim 3, wherein the capacity of the liquid reservoir is set to 2 to 4 μL, whereas the capacity of the flow path is set to no more than 2 μL.

5. The liquid reserving analytical tool according to claim 2, wherein the flow path and the liquid reservoir are provided on a plate member, and
wherein a dimension of the liquid reservoir in a thickness direction of the plate member is larger than a dimension of the flow path in the thickness direction.

6. The liquid reserving analytical tool according to claim 5, wherein a dimension of the liquid reservoir in a width direction and a dimension of the flow path in the width direction are equal or generally equal to each other.

7. The liquid reserving analytical tool according to claim 2, further comprising a first plate member, and a second plate member stacked on the first plate member via at least one spacer.

8. The liquid reserving analytical tool according to claim 7, wherein said at least one spacer includes at least one first spacer and at least one second spacer,
wherein a dimension of the flow path in a thickness direction of the first and the second plate members is defined by said at least one first spacer, and
wherein a dimension of the liquid reservoir in the thickness direction is defined by said at least one first spacer and at least one second spacer.

9. The liquid reserving analytical tool according to claim 8, wherein said at least one first spacer defines a dimension of the flow path in a width direction.

10. The liquid reserving analytical tool according to claim 9, wherein said at least one first spacer and at least one second spacer include a cutout for defining a dimension of the liquid reservoir in the width direction.

11. The liquid reserving analytical tool according to claim 10, wherein the cutout of said at least one first spacer and at least one second spacer has a width which increases as the cutout extends away from the flow path in a direction opposite from the movement direction.

12. The liquid reserving analytical tool according to claim 8, wherein said at least one second spacer includes a plurality of spacers stacked in the thickness direction.

13. The liquid reserving analytical tool according to claim 7, wherein at least one of the first plate and the second plate includes a bulging portion which projects in the thickness direction of the first and the second plates to secure the capacity of the liquid reservoir.

14. The liquid reserving analytical tool according to claim 13, wherein the sample introduction port is open in a direction opposite from the movement direction.

15. The liquid reserving analytical tool according to claim 7, wherein at least one of the first plate and the second plate includes a recess denting in the thickness direction of the first and the second plates to secure the capacity of the liquid reservoir.

16. The liquid reserving analytical tool according to claim 15, wherein the sample introduction port is open in the thickness direction.

17. The liquid reserving analytical tool according to claim 1, wherein the suction force to act on the flow path and the liquid reservoir is caused by capillary action.

18. The liquid reserving analytical tool according to claim 1, wherein, in the flow path, a reagent portion is provided which shows a color in accordance with an amount of a target component contained in the sample so that analysis of the target component can be performed by an optical method.

19. The liquid reserving analytical tool according to claim 1, wherein the tool is adapted to use a biochemical sample.

20. The liquid reserving analytical tool according to claim 19, wherein the tool is so designed that the sample introduction port can be brought into close contact with skin to extract blood from the skin when whole blood is used as the sample; and
wherein the sample introduction port is in the form of a regular polygon or generally regular polygon, or is circular or generally circular.
